(19) United States
(12) Patent Application Publication
(10) Pub. No.: US 2019/0130727 A1
(43) Pub. Date: May 2, 2019

(54) SMART MAT, LOCATING SYSTEM AND LOCATING METHOD

(71) Applicant: Lite-On Technology Corporation, Taipei (TW)

(72) Inventors: Chia-Ching Wu, Taipei (TW); Yi-Chi Kao, Taipei (TW)

(73) Assignee: Lite-On Technology Corporation, Taipei (TW)

(21) Appl. No.: 15/839,879

(22) Filed: Dec. 13, 2017

(30) Foreign Application Priority Data
Nov. 1, 2017 (TW) 106137722

(51) Int. Cl. G08B 21/04; G08B 21/02

(52) U.S. Cl. CPC G08B 21/0492; G08B 21/0275; G08B 21/0461

(57) ABSTRACT

A smart mat including a pressure sensor, a recognition element, a communication element, a controller and a mat body. The pressure sensor is configured to sense a pressure signal. The recognition element is configured to read an identification tag. The communication element is coupled to an external device and configured to transmit data. The controller is coupled to the pressure sensor, the recognition element and the communication element, and activated by the pressure signal. The mat body is configured to accommodate the pressure sensor, the recognition element, the communication element and the controller. After being activated by the pressure signal, the controller transmits the identification tag to the external device through the communication element. In addition, a locating system and a locating method using the smart mat are also provided.

### CROSS REFERENCE TO RELATED APPLICATION

This application claims the priority benefit of Taiwan application serial no. 106137722, filed on Nov. 1, 2017. The entirety of the above-mentioned patent application is hereby incorporated by reference herein and made a part of specification.

### BACKGROUND

### Field of the Invention

The invention relates to a smart mat, a locating system, and a locating method.

### Description of Related Art

In recent years, the speed of population aging becomes faster. In busy metropolises, children cannot take care of their elders at all times. Therefore, home care becomes more and more important, home care institutions and care dispatch centers are also established everywhere.

Even with elderly care or patient care facilities, the caregivers cannot one on one take care of all elders or patients. Therefore, these facilities are often equipped with electric eyes or pressure sensing devices installed indoors, so as to immediately know the positions and status of elders or patients. However, personnel is needed all the time to supervise when using the electric eyes, there is a lack of user-friendly warning system. On the other hand, the pressure sensing devices can only obtain information of heavy objects or pressure in a particular location, and cannot determine the source of pressure. For example, the pressure may come from a falling cupboard and may also come from people moving around, and the pressure sensing device cannot distinguish the differences and cannot further recognize the identities of the people walking around. As a result, the caregivers cannot provide the most appropriate care or treatment according to different requirements of different people.

### SUMMARY

The invention provides a smart mat, a locating system, and a locating method capable of determining the locations of the people and recognizing the identities of the people at the same time.

A smart mat of the invention includes a pressure sensor, a recognition element, a communication element, a controller and a mat body. The pressure sensor is configured to sense a pressure signal. The recognition element is configured to read an identification tag. The communication element is coupled to an external device and configured to transmit data. The controller is coupled to the pressure sensor, the recognition element and the communication element, and activated by the pressure signal. The mat body is configured to accommodate the pressure sensor, the recognition element, the communication element and the controller. After being activated by the pressure signal, the controller transmits the identification tag to the external device through the communication element.

A locating system of the invention includes a plurality of smart mats and an electronic device. The electronic device is coupled to the smart mats. Each of the smart mats includes a pressure sensor, a recognition element, a communication element, a controller and a mat body. The pressure sensor is configured to sense a pressure signal. The recognition element is configured to read an identification tag. The communication element is coupled to the electronic device and configured to transmit data. The controller is coupled to the pressure sensor, the recognition element and the communication element, and activated by the pressure signal. The mat body is configured to accommodate the pressure sensor, the recognition element, the communication element and the controller. After being activated by the pressure signal, the controller transmits the identification tag to the electronic device through the communication element.

A locating method of the invention is applicable to a locating system including a plurality of smart mats and an electronic device. The locating method includes: sensing a first pressure signal by a first smart mat of the plurality of smart mats; reading a first identification tag by the first smart mat in response to the first pressure signal; and transmitting the first identification tag to the electronic device by the first smart mat.

Based on the above, the embodiments of the invention provide the smart mats, the locating system and the locating method adopting the smart mats, the short distance recognition elements are added into the smart mats to read the identification tags on the users when the smart mats are stepped on by the users. Accordingly, it is able to determine the locations of the people and recognize the identities of the people at the same time.

In order to make the aforementioned and other features and advantages of the invention more comprehensible, embodiments accompanying figures are described in detail below.

### BRIEF DESCRIPTION OF THE DRAWINGS

FIG. 1 is a schematic view depicting a locating system in one embodiment of the invention.

FIG. 2 is a flowchart depicting a locating method in one embodiment of the invention.

FIG. 3 is a schematic view depicting a locating method in one embodiment of the invention.

### DESCRIPTION OF THE EMBODIMENTS

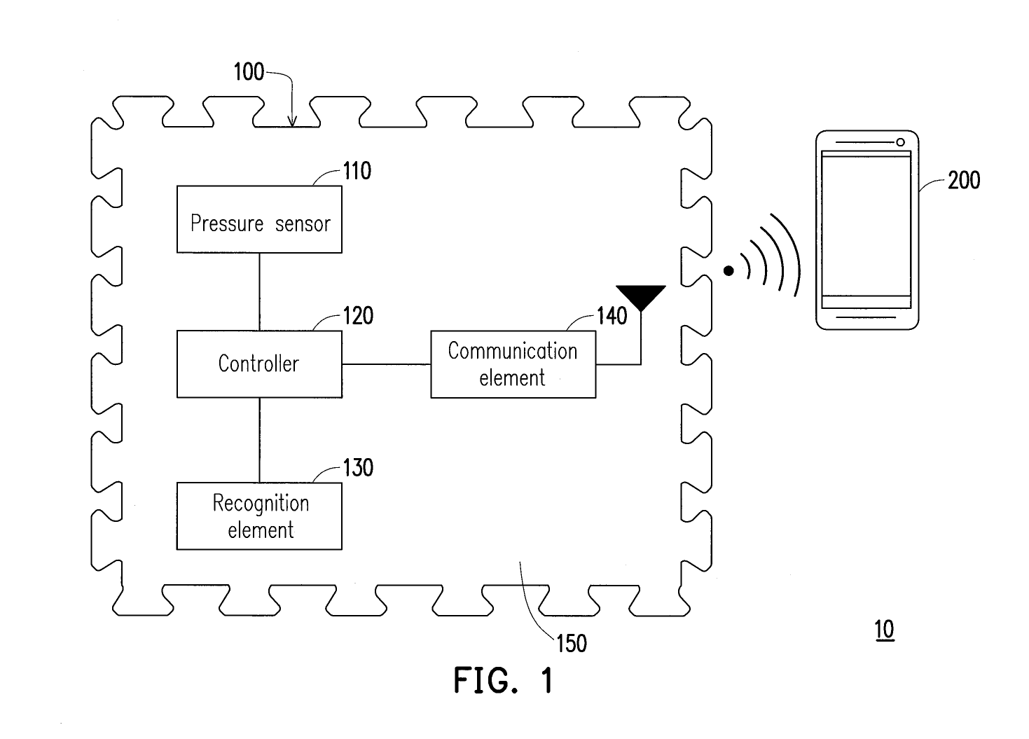

FIG. 1 is a schematic view depicting a locating system in one embodiment of the invention. Referring to FIG. 1, a locating system 10 includes a plurality of smart mats 100 and an electronic device 200. The smart mats 100 may be modular mats, designed as suitable sizes and geometric shapes, such as triangle, pentagon, diamond, and parallelogram, etc., according to space requirement. The smart mats 100 of the present embodiment are interlocking floor mats, a plurality of smart mats 100 are interlocked with each other and then placed on the indoor floor in order to provide indoor locating information for the electronic device 200.

In one embodiment, each of the smart mats 100 has recognition message (such as recognition code), and the electronic device 200 uses the recognition message to record the position of each of the smart mats 100 when placing the smart mats 100. As a result, when receiving a recognition message sent by one of the smart mats 100, the electronic device 200 can determine the location that the recognition message comes from based on the recorded position of each of the smart mats 100.

In one embodiment, each of the smart mats 100 has recognition message (such as recognition code), and the location of each of the smart mats 100 is, for example, recorded in the server or base station by using recognition message when the smart mats 100 are placed. The server or base station can integrate messages from a plurality of the smart mats 100 and then forward to the electronic device 200. For example, the server or base station can convert recognition messages from one of the smart mats 100 to location information and then transmit to the electronic device 200.

Accordingly, the smart mat 100 attaches its own recognition message while transmitting messages to the electronic device 200, so that according to this recognition message, the electronic device 200 can obtain the location of the smart mat 100 which is the source of the recognition message.

However, the smart mats 100 in the present embodiment of the invention may also be placed anywhere, such as on the ground outdoors or on a wall, etc. In addition, it is worth to mention here, only one smart mat 100 is shown in FIG. 1 for convenience of explaining it in detail.

In the present embodiment, each smart mat 100 includes a pressure sensor 110, a controller 120, a recognition element 130, a communication element 140, a mat body 150, and a power source (not shown) used to supply the smart mat 100, wherein the power source may be a battery. Wherein, the controller 120 is coupled to the pressure sensor 110, the recognition element 130 and the communication element 140, and the pressure sensor 110, the controller 120, the recognition element 130, the communication element 140, and the power source are all accommodated in the mat body 150.

In the present embodiment, the pressure sensor 110 is configured to sense pressure signal. To be specific, when the mat body 150 does not receive an external force, the pressure sensor 110 cannot sense any pressure signal. When a person walks on the mat body 150, the pressure sensor 110 will sense a pressure signal.

In the present embodiment, the controller 120 is, for example, a Central Processing Unit (CPU), a Microprocessor programmed for general purpose or special purpose, a Digital Signal Processor (DSP), a programmable controller, Application Specific Integrated Circuits (ASIC), Programmable Logic Device (PLD), combination thereof, or other similar devices. Specifically, the controller 120 is activated by the pressure signal sensed by the pressure sensor 110. When the pressure sensor 110 does not sense any pressure signal, the controller 120 is, for example, in hibernating state to save power. When the pressure sensor 110 senses a pressure signal, it possibly indicates that a person walks pass the mat body 150, so the controller 120 is activated and starts working.

In the present embodiment, the recognition element 130 is a Near-Field Communication (NFC) module configured to read the NFC tag serving as the identification tag outside the mat body 150. However, the type of the recognition element 130 is not limited to NFC module in the present embodiment of the invention. In other embodiments, the recognition element 130 may also be Radio Frequency

Identification (RFID) module or other similar modules configured to read RFID tag outside the mat body 150 or a tag corresponding to similar modules.

Specifically, in the present embodiment of the invention, the reading range of the recognition element 130 does not exceed the coverage of the mat body 150. Accordingly, when the mat bodies 150 of the two smart mats 100 are interlocked with each other, a situation that the recognition element 130 of one of the smart mats 100 reads the identification tag located at the surface of the mat body 150 of another smart mat 100 and causes misrecognition is avoided as well as possible.

In the present embodiment, the communication element 140 is wirelessly coupled to the electronic device 200, and the communication element 140 is a modem using Narrowband Internet-of-Things (NB-IoT) technology, for example. Specifically, the modem using NB-IoT technology can effectively reduce power and can reduce the frequency of replacing power source. However, the embodiments of the invention are not limited to any specific implementation of the communication element 140, as long as data is transmitted to the electronic device 200.

In the present embodiment, the mat body 150 is made of Polyethylene (PE), Ethylene, or Ethylene Vinyl Acetate (EVA), but the invention is not limited thereto. In other words, as long as the pressure sensor 110 inside the mat body 150 is able to sense pressure signal when the mat body 150 receives an external pressure, people skilled in the art can manufacture the mat body 15 according to their needs.

In the present embodiment, the electronic device 200 may be a computing device, such as desktop computer, notebook, tablet PC, ultra-mobile PC (UMPC), personal digital assistant (PDA), smart phone, mobile phone, playstation portable (PSP), work station, base station, or server, etc., the invention is not limited thereto.

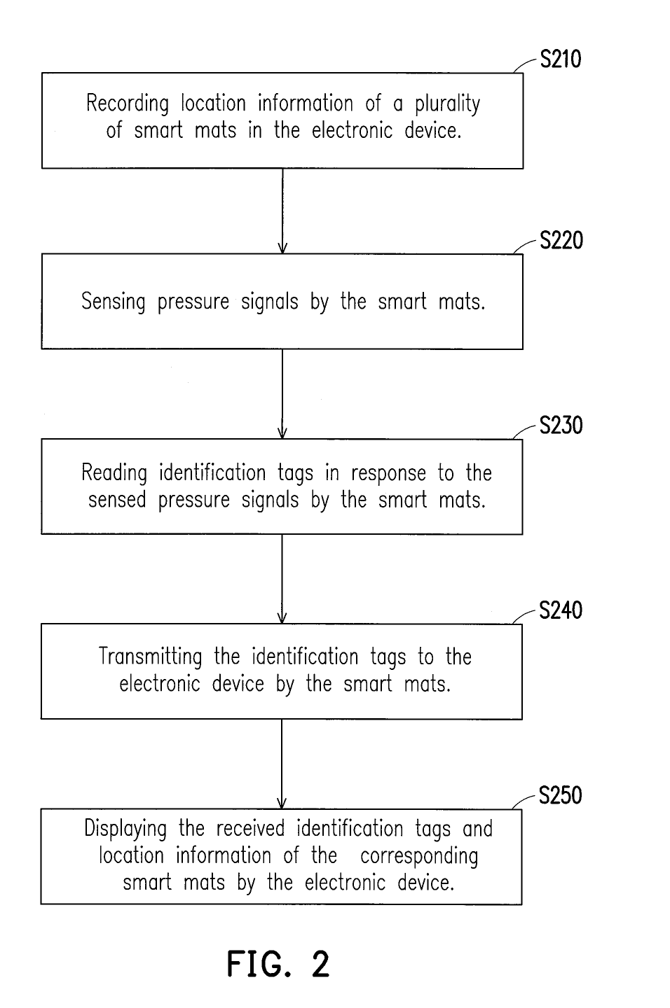

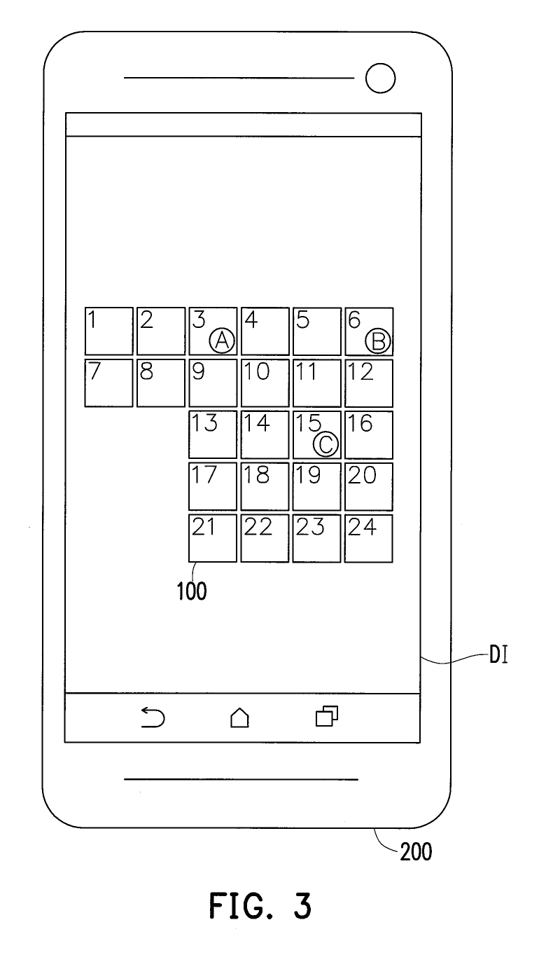

FIG. 2 is a flowchart depicting a locating method in one embodiment of the invention, and FIG. 3 is a schematic view depicting a locating method in one embodiment of the invention. The locating method in the present embodiment is applicable to the locating system 10 introduced in the embodiment of FIG. 1, so the locating system 10 and its components are used to introduce the locating method of the embodiment of the invention in the following description.

Referring to FIG. 2 and FIG. 3, in step S210, the electronic device 200 uses the recognition message to record the locations of a plurality of the smart mats 100. In the present embodiment, as shown in FIG. 3, 24 smart mats 100 are, for example, fixed and placed indoors, the electronic device 200 uses the recognition messages from the smart mats 100 to record the relative location of each of the smart mats 100. For example, the record of the electronic device 200 includes each of the locating blocks shown in

FIG. 3. Namely, the recognition message of the smart mat 100 at the left-most of the first row is “1”, the recognition message of the smart mat 100 which is the second one from the left-most of the first row is “2”, and so on. As a result, the electronic device 200 records the location information of 24 smart mats 100 after being placed.

It is worth mentioning that the method of recording the positions of the smart mats 100 is not limited in the invention. In the above-mentioned embodiments, the electronic device 200 records relative locations between the smart mats 100. In other embodiments, the electronic device 200 may also, for example, record absolute locations of the smart mats 100 (such as longitude and latitude or user-defined interior coordinates, etc.).

In step S220, the smart mats 100 can sense pressure signal. In the present embodiment, for example, the first, second, and third users wear foot wear devices (such as shoes or socks) having different NFC tags A, B, and C, respectively, and the first, second, and third users walk on the first, second, and third smart mats 100 with recognition messages of “3”, “6”, and “15”, respectively, at the same time. Therefore, the pressure sensors 110 of the three smart mats 100 respectively sense the steps of the first, second, and third users and generate pressure signals and transmit the pressure signals to the controller 120.

In step S230, the smart mats 100 read identification tags in response to the sensed pressure signals. In step S240, the smart mats 100 transmit the identification tags to the electronic device 200. In the present embodiment, take a first smart mat 100 as an example, the recognition element 130 reads the NFC tag A wearing by the first user. After the controller 120 is activated by the pressure signal generated from the step of the first user, the controller 120 obtains the NFC tag A read by the recognition element 130. After that, the controller 120 transmits both of the NFC tag A obtained by the controller 120 and the recognition message “3” of the first smart mat 100 to the electronic device 200 through the communication element 140. With similar methods, the second and third smart mats 100 can also transmit the NFC tags B and C and the respective recognition messages “6” and “15” to the electronic device 200.

In step S250, the electronic device 200 provides a display interface DI, wherein the display interface DI displays the identification tags received by the electronic device 200 and marks the identification tags at the locations of the corresponding smart mats 100. In the present embodiment, take the first smart mat 100 as an example, first, the electronic device 200 finds out the source information (such as the location of the first smart mat 100) according to the recognition message “3”. After finding out the location, the electronic device 200 is able to mark the location with the corresponding identification tag A, as shown in FIG. 3. Similarly, the electronic device 200 finds out the location of the second smart mat 100 according to the recognition message “6” and mark the location with the identification tag B, and finds out the location of the third smart mat 100 according to the recognition message “15” and mark the location with the identification tag C, as shown in FIG. 3.

As a result, when implementing the locating method in the embodiments of the invention, the user is able to instantly know the locations of the people wearing foot wear devices with identification tag through the electronic device 200, so as to recognize identity of person at each location marked with identification tag.

It is worth mentioning that, in another embodiment, the electronic device 200 may also be a base station or server. After the base station or the server receives the identification tag and the corresponding recognition message, the location of the smart mat 100 that the identification tag comes from is calculated according to the method introduced above, and then the messages after being integrated is transmitted to mobile devices of one or a plurality of users. After receiving the integrated messages from the electronic device 200, the user's mobile device displays information on the display interface DI according to integrated messages, as shown in FIG. 3. In other words, the type and the number of devices used for displaying are not limited in the embodiments of the invention, people skilled in the art can implement according to their needs.

In summary, in the smart mats, the locating system and the locating method adopting the smart mats provided by the embodiments of the invention, the short distance recognition elements are added into the smart mats to read the identification tags on the users when the smart mats are stepped on by the users. Accordingly, it is able to determine the locations of the people and recognize the identities of the people at the same time. Moreover, since it is inconvenient to move the mats placed indoors, the communication element in the embodiments of the invention use narrowband internet of things technology, so as to reduce electricity consumption and greatly reduce the frequency of changing the power source of the smart mat.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

1-5. (canceled)

6. A locating system, comprising:
a plurality of smart mats; and
an electronic device, coupled to the smart mats,
wherein each of the smart mats comprises:
a pressure sensor, configured to sense a pressure signal;
a recognition element, configured to read an identification tag;
a communication element, coupled to an electronic device and configured to transmit data;
a controller, coupled to the pressure sensor, the recognition element and the communication element, and activated by the pressure signal; and
a mat body, configured to accommodate the pressure sensor, the recognition element, the communication element and the controller, wherein after being activated by the pressure signal, the controller transmits the identification tag and a recognition message corresponding to the smart mat to the electronic device through the communication element,
wherein the electronic device is further configured to:
obtain a location of the smart mat corresponding to the identification tag according to the recognition message; and
provide a display interface marking the identification tag at the location of the smart mat corresponding to the identification tag.

7. The locating system as recited in claim 6, wherein a reading range of the recognition element is smaller than or equal to a coverage of the mat body.

8. The locating system as recited in claim 6, wherein the recognition element is a near field communication module and the identification tag is a near field communication tag, or the recognition element is a radio frequency identification module and the identification tag is a radio frequency identification tag.

9-11. (canceled)

12. A locating method, applicable to a locating system comprising a plurality of smart mats and an electronic device, the locating method comprises:
sensing a first pressure signal by a first smart mat of the plurality of smart mats;
reading a first identification tag by the first smart mat in response to the first pressure signal; and
transmitting the first identification tag and a first recognition message of the first smart mat to the electronic device by the first smart mat;
obtaining a first location of the first smart mat according to the first recognition message by the electronic device; and
providing a display interface marking the first identification tag at the first location by the electronic device.

13-14. (canceled)

15. The locating method as recited in claim 12, wherein the first identification tag is a near field communication tag or a radio frequency identification tag.

16. (canceled)
